(19) United States
(12) Patent Application Publication
(10) Pub. No.: US 2026/0343210 A1
(43) Pub. Date: Oct. 29, 2026

(54) FREQUENCY AND TIME TRACKING OF CHANNEL

(71) Applicant: Nokia Technologies Oy, Espoo (FI)

(72) Inventors: Timo KOSKELA, Oulu (FI); Mihai ENESCU, Espoo (FI); Juha Pekka KARJALAINEN, Oulu (FI); Sami-Jukka HAKOLA, Oulu (FI); Sanjay GOYAL, Murray Hill, NJ (US)

(21) Appl. No.: 19/191,700

(22) Filed: Apr. 28, 2025

(51) Int. Cl. H04W 8/22; H04L 1/00; H04L 5/00

(52) U.S. Cl. CPC H04W 8/22; H04L 1/0003; H04L 5/0051; H04L 5/0005

(57) ABSTRACT

Example embodiments of the present disclosure are directed to frequency and time tracking of a channel. In a method, an apparatus determines whether the apparatus is capable of performing a frequency and time tracking of a channel within a tracking time using a first tracking reference signal (TRS) and a demodulation reference signal (DMRS). In accordance with a determination that the apparatus is capable of performing the frequency and time tracking within the tracking time, the apparatus transmits, to a further apparatus, information associated with the determination. In accordance with a determination that the apparatus is not capable of performing the frequency and time tracking within the tracking time value, the apparatus transmits, to a further apparatus, a request for a second TRS.

### FIELD

Various example embodiments of the present disclosure generally relate to the field of telecommunication and in particular, to methods, devices, apparatuses and computer readable storage medium for frequency and time tracking of a channel.

### BACKGROUND

A communication network may serve as a facility that enables communication between two or more communication devices or provides communication devices access to a data network. A mobile or wireless communication network is one example of a communication network. A communication device may be provided with a service by an application server.

In some communication systems such as the next cellular systems, user equipment (UE) may perform a channel estimation by measuring a reference signal (RS) from the network. For example, the reference signal may be a channel state information (CSI)-RS. The CSI-RS may be UE-specifically configured via radio resource control (RRC) signaling. It is proposed that a tracking reference signal (TRS), which may be a variant of CSI-RS or a separate RS, may be used for assisting UE in channel estimation.

### SUMMARY

In a first aspect of the present disclosure, there is provided an apparatus. The apparatus comprises at least one processor; and at least one memory storing instructions that, when executed by the at least one processor, cause the apparatus to: determine whether the apparatus is capable of performing a frequency and time tracking of a channel within a tracking time using a first TRS and a DMRS; in accordance with a determination that the apparatus is capable of performing the frequency and time tracking within the tracking time, transmit to a further apparatus information associated with the determination; and in accordance with a determination that the apparatus is not capable of performing the frequency and time tracking within the tracking time value, transmit to the further apparatus a request for a second TRS.

In a second aspect of the present disclosure, there is provided an apparatus. The apparatus comprises at least one processor; and at least one memory storing instructions that, when executed by the at least one processor, cause the apparatus to: transmit, to a further apparatus, a first TRS, and a DMRS; receive, from the further apparatus, information comprising at least one of: an indication for an extension of a tracking time of the first TRS for a frequency and time tracking of a channel, information indicating that tracking performance of the frequency and time tracking with the first TRS and the DMRS is valid, or a request for a second TRS.

In a third aspect of the present disclosure, there is provided a method. The method comprises: determining whether the apparatus is capable of performing a frequency and time tracking of a channel within a tracking time using a first TRS and a DMRS; in accordance with a determination that the apparatus is capable of performing the frequency and time tracking within the tracking time, transmitting to a further apparatus information associated with the determination; and in accordance with a determination that the apparatus is not capable of performing the frequency and time tracking within the tracking time value, transmitting to the further apparatus a request for a second TRS.

In a fourth aspect of the present disclosure, there is provided a method. The method comprises: transmitting, to a further apparatus, a first TRS, and a DMRS; receiving, from the further apparatus, information comprising at least one of: an indication for an extension of a tracking time of the first TRS for a frequency and time tracking of a channel, information indicating that tracking performance of the frequency and time tracking with the first TRS and the DMRS is valid, or a request for a second TRS.

In a fifth aspect of the present disclosure, there is provided an apparatus. The apparatus comprises means for determining whether the apparatus is capable of performing a frequency and time tracking of a channel within a tracking time using a first TRS and a DMRS; means for in accordance with a determination that the apparatus is capable of performing the frequency and time tracking within the tracking time, transmitting to a further apparatus information associated with the determination; and means for in accordance with a determination that the apparatus is not capable of performing the frequency and time tracking within the tracking time value, transmitting to the further apparatus a request for a second TRS.

In a sixth aspect of the present disclosure, there is provided an apparatus. The apparatus comprises means for transmitting, to a further apparatus, a first TRS, and a DMRS; means for receiving, from the further apparatus, information comprising at least one of: an indication for an extension of a tracking time of the first TRS for a frequency and time tracking of a channel, information indicating that tracking performance of the frequency and time tracking with the first TRS and the DMRS is valid, or a request for a second TRS.

In a seventh aspect of the present disclosure, there is provided a computer readable medium. The computer readable medium comprises instructions stored thereon for causing an apparatus to perform at least the method according to the third aspect, or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example diagram for TRS configuration options in accordance with some example embodiments of the present disclosure;

FIG. 3 illustrates an example signaling flow for frequency and time tracking indication in accordance with some example embodiments of the present disclosure;

FIG. 4 illustrates another example signaling flow for frequency and time tracking indication in accordance with some example embodiments of the present disclosure;

FIG. 5 illustrates an example signaling flow for frequency and time tracking performance indication in accordance with some example embodiments of the present disclosure;

FIG. 6 illustrates a flowchart of a method implemented at a first apparatus in accordance with some example embodiments of the present disclosure;

FIG. 7 illustrates a flowchart of a method implemented at a second apparatus in accordance with some example embodiments of the present disclosure;

FIG. 8 illustrates a flowchart of a method implemented at a first apparatus in accordance with some example embodiments of the present disclosure;

FIG. 9 illustrates a flowchart of a method implemented at a second apparatus in accordance with some example embodiments of the present disclosure;

FIG. 10 illustrates a simplified block diagram of a device that is suitable for implementing example embodiments of the present disclosure; and FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not necessarily indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a user device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5G-advanced, the sixth generation (6G) communication protocols, wireless local network communication protocols such as Institute for Electrical and Electronics Engineers (IEEE) 802.11 and the like, and/or any other protocols either currently known or to be developed in the future. Embodiments of the present disclosure may be applied in various communication systems. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a user device accesses the network and receives services therefrom. The network device may refer to a base station (BS) or an access point (AP), for example, a node B (NodeB or NB), an evolved NodeB (eNodeB or eNB), a next generation NB (also referred to as a gNB), a remote radio unit (RRU), a radio head (RH), a remote radio head (RRH), a relay, an integrated access and backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a centralized unit (CU) and a distributed unit (DU). The CU may control a plurality of DUs acting at least as transmit/receive (Tx/Rx) nodes. In some embodiments, the DUs may comprise e.g., a radio link control (RLC) layer, a medium access control (MAC) layer and a physical (PHY) layer, whereas the CU may comprise the layers above RLC layer, such as a packet data convergence protocol (PDCP) layer, a radio resource control (RRC) and an internet protocol (IP) layer. An IAB node comprises a mobile terminal (IAB-MT) part that behaves like a UE toward the parent node, and a DU part of an IAB node behaves like a base station toward the next-hop IAB node.

The term “user device” or “terminal device” refers to any end device that may be capable of wireless communication. By way of example rather than limitation, a user device may also be referred to as user equipment (UE), a subscriber station (SS), a portable subscriber station, a mobile station (MS), or an access terminal (AT). The user device may include, but not limited to, a mobile phone, a cellular phone, a smart phone, voice over IP (VOIP) phones, wireless local loop phones, a tablet, a wearable user device, a personal digital assistant (PDA), portable computers, desktop computer, image capture user devices such as digital cameras, gaming user devices, music storage and playback appliances, vehicle-mounted wireless user devices, wireless endpoints, mobile stations, laptop-embedded equipment (LEE), laptop-mounted equipment (LME), universal serial bus (USB) dongles, smart devices, wireless customer-premises equipment (CPE), an internet of things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The user device may also correspond to a mobile termination (MT) part of an IAB node (e.g., a relay node). In the following description, the terms “user device”, “terminal device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a user device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

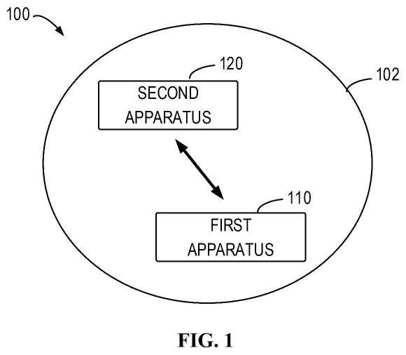

FIG. 1 illustrates an example communication environment 100 in which example embodiments of the present disclosure can be implemented. As shown in FIG. 1, the communication environment 100 may include a first apparatus 110, which may operate as a terminal device such as UE. The communication environment 100 may further include a second apparatus 120, which may operate as a BS or a gNB serving the UE. The serving area of the second apparatus 120 may be called a cell 102.

In some example embodiments, the second apparatus 120 may be coupled with or equipped with one or more transmission and reception points (TRPs). The second apparatus 120 may transmit at least one RS to the first apparatus 110 via the one or more TRPs. The at least one RS may include CSI-RS, TRS, demodulation RS, and/or the like.

In some example embodiments, a communication direction from the second apparatus 120 to the first apparatus 110 may be referred to as a downlink (DL), and a communication direction from the first apparatus 110 to the second apparatus 120 may be referred to as an uplink (UL). In DL, the second apparatus 120 may be a transmitting (TX) device (or a transmitter) and the first apparatus 110 may be a receiving (RX) device (or a receiver). In UL, the first apparatus 110 may be a TX device (or a transmitter) and the second apparatus 120 may be an RX device (or a receiver).

It is to be understood that the number or type of apparatuses and their connections shown in FIG. 1 are only for the purpose of illustration without suggesting any limitation. The communication environment 100 may include any suitable number or type of apparatuses or devices configured to implement some example embodiments.

In communication systems, a TRS, which may be a variant of CSI-RS or a separate RS, may be used to assist the UE in performing channel estimation for the purpose of receiving downlink signals and channels such as the physical downlink control channel (PDCCH) and physical downlink shared channel (PDSCH). Based on the TRS, the UE may perform time and frequency synchronization tracking, as well as estimation of long-term doppler shift, doppler spread, delay spread, and average delay. In some communication systems, a periodic TRS may be configured for each UE. The periodic TRS may be transmitted using a cell-specific synchronization signal and/or physical broadcast channel (SS/PBCH, SSB) beam.

The TRS may be configured as one-port CSI-RS resource(s) with several parameters, including but not limited to a TRS burst length, TRS burst periodicity, and/or the like. The TRS burst length may include two consecutive valid downlink slots in frequency range 1 (FR1), and either one or two consecutive valid downlink slots in frequency range 2 (FR2). Within each TRS slot, there may be two TRS symbols. These TRS symbols may be arranged such that there may be a separation of three symbols between them in the slot. The periodicity of the TRS burst may be configured as any suitable number such as 10 ms, 20 ms, 40 ms, 80 ms, and/or the like.

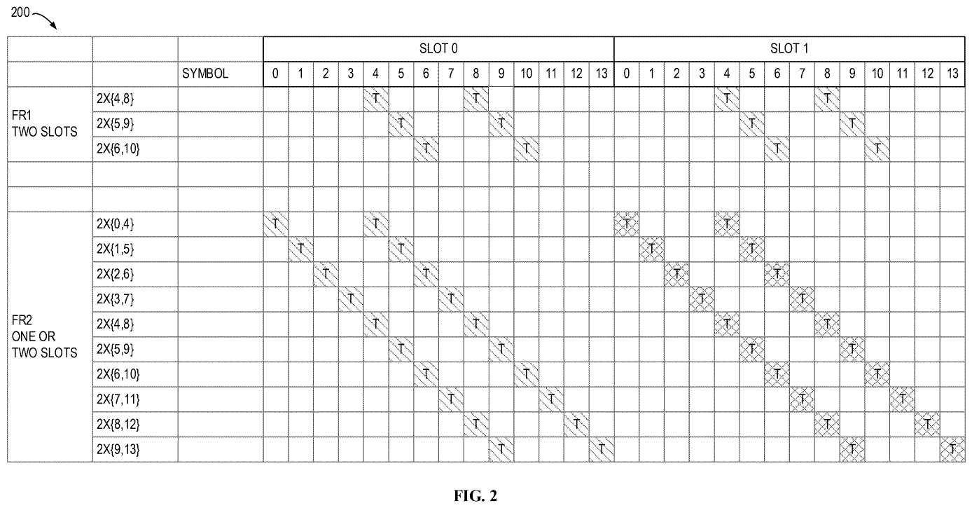

FIG. 2 illustrates an example 200 for different TRS configuration options within the TRS slots, providing an understanding of the TRS configuration options in terms of symbol positions within downlink slots for both the FR1 and the FR2. As illustrated, for the FR1, the TRS may be configured over two consecutive slots (i.e., slot 0 and slot 1). Each TRS slot includes two TRS symbols that are separated by several symbols, such as symbols #4 and #8, or symbols #5 and #9, and the like.

For the FR2, the TRS may be configured over either one or two consecutive downlink slots. For example, the slot 0 may include two TRS symbols that are separated by several symbols, such as symbols #0 and #4, or symbols #1 and #5, and the like. Alternatively, or in addition, the slot 1 may include two TRS symbols that are separated by several symbols, such as symbols #0 and #4, or symbols #1 and #5, and the like. FIG. 2 presents multiple example TRS symbol combinations and for example the two TRS symbols may be inserted per slot with a fixed separation of several symbols.

In communication systems such as 5G communication system, the TRS may be periodic and UE-specific. That is, the TRS may be configured separately for each UE. There may also be an additional aperiodic TRS, but the aperiodic TRS may be associated with the periodic TRS and shares the same QCL source as the periodic TRS, such as for example, a synchronization signal and PBCH block (SSB) in communication systems, which may include primary and secondary synchronization signals, and PBCH and DMRS for PBCH demodulation.

A UE configured with non-zero power (NZP)-CSI-RS-ResourceSet(s) configured with higher layer parameter trs-Info may have the CSI-RS resources configured as: (1) periodic, with the CSI-RS resources in the NZP-CSI-RS-ResourceSet configured with same periodicity, bandwidth and subcarrier location; and/or (2) periodic CSI-RS resource in one set and aperiodic CSI-RS resources in a second set, with the aperiodic CSI-RS and periodic CSI-RS resource having the same bandwidth (with same RB location) and the aperiodic CSI-RS being configured with qcl-Type set to ‘typeA’ and ‘typeD’, where applicable, with the periodic CSI-RS resources.

A common TRS may be detected and used by UEs in IDLE or INACTIVE mode for the purpose of updating channel estimation filter parameters such as an average delay, a delay spread, a doppler shift, and a doppler spread.

Several QCL relations are supported, including but not limited to: ‘QCL-typeA’: {Doppler shift, Doppler spread, average delay, delay spread} , ‘QCL-TypeB’: {Doppler shift, Doppler spread}, ‘QCL-typeC’: {Doppler shift, average delay} , ‘QCL-typeD’: {Spatial Rx parameter}. The QCL relations may extend from the SSB and P-TRS to the DMRS of PDCCH, DMRS of PDSCH, and CSI-RS for CSI, using QCL-typeA and QCL-typeD, and from SSB using QCL-typeC and QCL-typeD.

In communication systems such as 5G systems, the TRS may be configured and triggered by a network. The TRS may be either periodic only or both periodic and aperiodic and the aperiodic TRS may be associated with the periodic TRS.

In some communication systems, one use case of the TRS may be to enable the UE to perform tracking of radio channel characteristics in both time and frequency domains. By doing so, the UE may compensate for variations in these characteristics, which in turn may support higher peak data rates. The TRS may facilitate the use of higher order modulation schemes, including those beyond 16 quadrature amplitude modulation (QAM). The UE may expect a configuration of the periodic TRS, as it serves as the QCL source.

The aperiodic TRS (aTRS) may be associated with the periodic TRS, meaning that aperiodic TRS may not be transmitted independently of the periodic TRS. A requirement of more energy efficiency of communication systems may drive system designs toward relying solely on the aperiodic TRS, or on TRS that may not be persistently present. The UE may encounter certain channel conditions that may not be visible to the network and the UE(s) may require different TRS characteristics during the communication. In such scenarios, it may be beneficial for the network to be aware or informed with tracking performance of the UE.

In accordance with some example embodiments, there are provided solutions for improving a frequency and time tracking of a channel. In some example embodiments, a first apparatus determines information associated with a frequency and time tracking of a channel. The first apparatus subsequently transmits the determined information to a second apparatus. The determined information indicates at least information of a tracking time value associated with a period of time for the frequency and time tracking or tracking performance information for the frequency and time tracking.

In this way, the second apparatus may be informed about the tracking capability or status of the first apparatus, such that the second apparatus may determine whether additional reference signals are needed or whether current tracking conditions are valid or sufficient. This may enable the system to reduce reliance on periodic transmission of tracking reference signals and instead support adaptive signaling based on actual tracking needs, thereby contributing to improved energy efficiency.

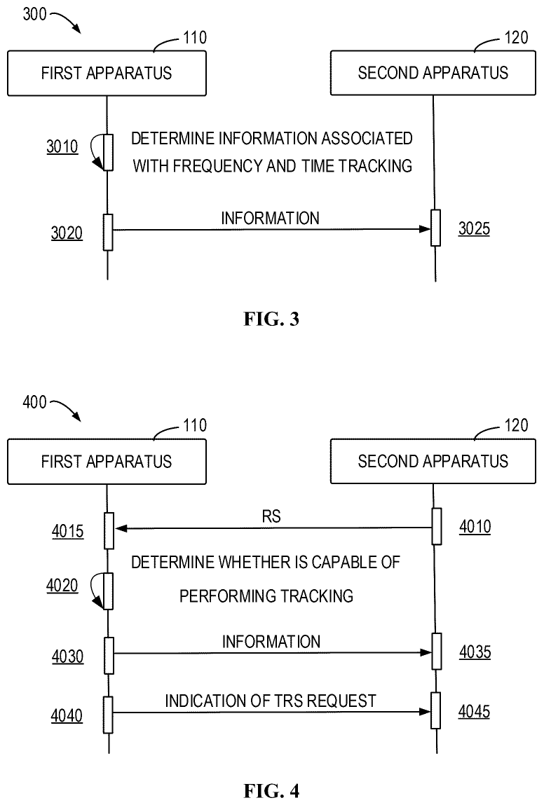

Reference is now made to FIG. 3, which illustrates an example signaling flow 300 for indicating a frequency and time tracking of a channel according to some example embodiments. The signaling flow 300 involves the first apparatus 110 and the second apparatus 120.

As illustrated in FIG. 3, the first apparatus 110 determines (3010) information associated with a frequency and time tracking of a channel. The frequency and time tracking of a channel may be performed by the first apparatus 110 based on one or more RSs such as TRS(s) from the second apparatus 120. For the purpose of discussion, the frequency and time tracking of a channel may be referred to as “channel tracking” or “tracking” that tracks characteristics of the channel on at least one of frequency domain or time domain. The information associated with the frequency and time tracking may be referred to as “channel tracking related information” or “tracking related information”.

In an example, the tracking related information indicates information of a tracking time value associated with a period of time for the frequency and time tracking. The tracking time value associated with a period of time for channel tracking may refer to the time value of the period of time for channel tracking, a minimum time value of the period of time, a maximum time value of the period of time, or any other value related to the channel tracking time. As used herein, the tracking time value may be referred to as “tracking time T”. The tracking time value indicates how long the first apparatus is able to perform tracking or meet a tracking performance requirement, based on a currently configured RS.

Alternatively, or in addition, in another example, the tracking related information indicates tracking performance information. In some examples, the tracking performance information may be a tracking performance report including at least the tracking time value.

The first apparatus 110 subsequently transmits (3020) to the second apparatus 120, the determined tracking related information. Correspondingly, the second apparatus 120 receives (3025) from the first apparatus 110 the determined information. In some example embodiments, the transmission of the tracking related information may be caused by a determination that a current tracking time value or a previously reported tracking time value is invalid or unsuitable. In some example embodiments, the transmission of the information associated with the frequency and time tracking may be caused by a change to the tracking time value. In some example embodiments, the transmission of the information associated with the frequency and time tracking may be caused by a reception of an aperiodic TRS. It is to be understood that these example triggers of the tracking related information transmission are only for the purpose of discussion, without suggesting any limitations.

The tracking related information may be transmitted via any appropriate signaling. In some example embodiments, the information may be transmitted in a tracking report, a CSI report, and/or the like. In some examples, the reporting of the tracking time value may be included as a part in a legacy or normal reporting. In some examples, the reporting of the tracking time value may be integrated into an existing reporting framework, such as legacy CSI reporting procedures. In some examples, if the first apparatus 110 determines that the tracking time value has changed or becomes invalid, the first apparatus 110 may transmit an updated tracking time value through a dedicated report in an earlier or expedited manner.

In some example embodiments, the information may be transmitted in uplink control information (UCI), a medium access control control element (MAC CE), an RRC message, and/or the like. It is to be understood that the signaling examples are listed merely for the purpose of illustration but do not imply any limitations. By transmitting (3020) the tracking related information to the second apparatus 120, the second apparatus 120 may be informed about the tracking time value and/or the tracking performance information. For example, the second apparatus 120 may be informed about whether the tracking performance is valid. Such tracking related information transmission may be used when the first apparatus 110 experiences certain channel conditions which are invisible for the second apparatus 120.

In some examples, the first apparatus 110 may be configured to perform tracking performance detection when it is being scheduled or is in an active time, such as when monitoring a PDCCH. This may allow the tracking evaluation to be aligned with actual transmission or control reception activities, thereby improving the relevance and efficiency of the reported tracking information.

In some examples, the tracking time may be a minimum or a maximum period of time with which the first apparatus 110 may be able to perform the channel tracking. For example, if the value is below a certain threshold, tracking may become unreliable and additional reference signals may be required. If the value is above a certain threshold, the tracking performance may be considered sufficient and periodic reference signals may be omitted to reduce signaling overhead.

The tracking related information transmission may be predefined, or (pre)-configured. In some example embodiments, the first apparatus 110 may receive a configuration for transmitting the information associated with the frequency and time tracking. The configuration may be configured by the second apparatus 120 and transmitted from the second apparatus 120 to the first apparatus 110. In some example embodiments, the configuration may include at least one condition for transmitting the information. The at least one condition may correspond to any suitable criteria that serve as a trigger for the first apparatus 110 to transmit the information. For example, upon satisfaction of any such condition, the first apparatus 110 may be triggered to transmit the determined information. In some example embodiments, the at least one condition may include a determination that the current or previously reported tracking time value becomes invalid or unsuitable. In some example embodiments, the at least one condition may be a change to the tracking time value. For example, if the current tracking time value is different from the last reported tracking time value, the first apparatus 110 may need to transmit the determined information. The at least one condition may further include a reception of the aperiodic TRS. Several example conditions for transmitting the tracking related information have been described. It is to be understood that any other suitable conditions may be applied for the tracking related information transmission. These conditions may be configured by the second apparatus 120, or configured by a previous serving device, or may be predefined. These conditions may be applied separately, or in any combination.

In some example embodiments, the configuration may include at least one configured tracking time value. In some examples, the at least one configured tracking time value may be considered as default value(s) for the tracking time value(s). In some examples, the first apparatus 110 may use the default value as the tracking time value. In some other examples, if the first apparatus 110 does not indicate or transmit the tracking time value, the second apparatus 120 may use the default value as the tracking time value.

In some example embodiments, the configuration may include indication of content of the information associated with the frequency and time tracking. In some examples, the configuration may specify the content or a format of the information. The content of the information may be any appropriate information to be used by the first apparatus 110 to inform the second apparatus 120 about the frequency and time tracking of the channel. For example, the information may be the tracking time value. For another example, the information may be information indicating whether the current tracking time value is valid or suitable for the first apparatus to perform the tracking according to certain pre-defined tracking requirements. For a further example, the information may be a tracking performance report including the tracking time value. Examples regarding the configuration for the tracking related information have been described. It is to be understood that the configuration may include less or more information. There may be a single configuration to carry the above-mentioned information or parameters, or may be several separate configurations. The configuration may be included in an RRC message, DCI, MAC CE, and/or the like.

In some example embodiments, the tracking time value may be determined based on at least one parameter associated with at least one RS. The at least one parameter may be a periodicity or interval of the RS, frequency allocation information such as bandwidth of the RS, a length associated with the RS, and/or the like. In an example, the tracking time value may be determined based on the periodicity of the RS. The tracking time value may be determined based on the length of the RS, such as a number of more than one consecutive symbol of the at least one RS, or a number of at least one symbol in a slot of the at least one RS, and/or the like. In another example, the tracking time value may be determined based on a bandwidth of the at least one RS. In a further example, the tracking time value may be determined based on a pre-configured value. In some examples, the pre-configured value may be configured by the network or the second apparatus 120 as a default value for the tracking time value. With one or more of these parameters of the at least one RS, the first apparatus 110 may estimate the tracking time value.

In some examples, the tracking time value may be a time value estimated by the first apparatus 110 based on one or more RSs. The RS may be any appropriate RS. In some example embodiments, the at least one RS may be a TRS. In some example embodiments, the TRS may be a periodic TRS, an aperiodic TRS, or a semi-persistent TRS. In some examples, the tracking time value may be determined based on a latest received RS such as the periodic TRS, aperiodic TRS, or semi-persistent TRS. For the purpose of discussion, some example embodiments will be described with respect to the aperiodic TRS. It is to be understood that these example embodiments described with respect to the aperiodic TRS may also be applied to the periodic TRS, the semi-persistent TRS, or the like.

Alternatively, or in addition, the at least one RS may include a DMRS. For example, the tracking time value may be determined based on the DMRS received in combination with the TRS, such as when both are used as reference signals for the PDCCH or PDSCH.

Alternatively, or in addition, in some example embodiments, the tracking time value may be determined based on a channel condition determined by the first apparatus 110. In some examples, the tracking time value may be based on current channel conditions which may be observed or estimated by the first apparatus 110. In some example embodiments, the channel condition may be determined (i.e., observed or estimated) based on the received TRS. For example, the first apparatus 110 may detect an increased Doppler spread or delay spread based on the received aperiodic TRS. In some example embodiments, the channel condition may be determined based on a QCL source RS of the TRS. In some example embodiments, the QCL source RS may be a CSI-RS. In some example embodiments, the QCL source RS may be an SSB. For example, the QCL source RS may provide spatial or frequency domain characteristics that assist in evaluating channel coherence time, which in turn supports tracking time value adjustment.

In some example embodiments, the determining may include determining the tracking time value based on a mobility status of the first apparatus 110. In some examples, if the first apparatus 110 is moving at a high speed, the tracking time value under the fast-varying channel condition is shorter than that under a slow-varying channel condition.

Several examples for determining the tracking time value have been described. These examples are only described for the purpose of illustration, without suggesting any limitations. These example determinations may be applied separately, or in any combination. Any other suitable approach may be applied to determine the tracking time value. Scope of the present disclosure is not limited here.

In some example embodiments, the information associated with the frequency and time tracking of the channel may indicate information of the tracking time value. In some example embodiments, the information of the tracking time value may include a first indication indicating the tracking time value and the tracking time value may indicate how long the first apparatus 110 is able to perform tracking or meet a tracking performance requirement, based on a currently configured RS. In some examples, the currently configured RS may be a periodic TRS, a semi-persistent TRS or an aperiodic TRS.

In some example embodiments, the first indication of the tracking time value may be represented in different formats depending on implementation requirements or signaling efficiency. In some example embodiments, the first indication of the tracking time value may be expressed in time, symbols, slots or codepoints mapping to configured predefined values. The first indication may be expressed in time, such as 40 milliseconds; in symbols, such as 28 OFDM symbols; in slots, such as 2 slots; or as a codepoint that maps to a predefined tracking time value, such as codepoint 3 corresponding to 40 milliseconds. It is to be understood that these example values and parameters are only for the purpose of illustration, without suggesting any limitations.

In some example embodiments, the information of the tracking time value may include a second indication indicating an extension of the current or previously reported tracking time value. For example, the first apparatus 110 may request an extension of the tracking time value if it determines that the current reference signal configuration remains sufficient or valid for continuing tracking without degradation in performance. This type of request may be expressed using N bits, for example to include the amount or duration of extension. In one example embodiment, the first apparatus 110 may indicate that the tracking performance is sufficient, which may be interpreted by the second apparatus 120 as an implicit indication to extend the tracking time.

In some example embodiments, the information of the tracking time value may include a third indication indicating that the current or previously reported tracking time value is valid. The tracking time value being valid means that the tracking time value is accurate or suitable. For example, the first apparatus 110 may report that the current tracking time value is valid under the observed channel conditions. The third indication may be expressed using 1 bit (or any other bit length) and the third indication may be more lightweighted and may be suitable in scenarios where the current tracking performance is acceptable, and frequent changes or additional signaling are not needed. This approach may enable the use of lightweight signaling to implicitly convey that tracking performance remains sufficient or valid.

In some example embodiments, the information of the tracking time value may include a fourth indication indicating that the current or previously reported tracking time value is invalid. The tracking time value being invalid means that the tracking time value is inaccurate or not suitable. For example, the first apparatus 110 may indicate that the current tracking time value is not valid anymore because the channel condition or mobility status has changed. The tracking time value being invalid means that the first apparatus 110 may change or update the tracking time value.

In some example embodiments, the information associated with the frequency and time tracking of the channel may indicate tracking performance information for the frequency and time tracking. The tracking performance information may reflect whether the first apparatus 110 is able to maintain sufficient tracking quality to support certain downlink transmission configurations.

In some example embodiments, the tracking performance information may include a fifth indication that the first apparatus 110 is able to meet the tracking performance requirement for at least one of: MCS, or rank, of a physical shared channel (i.e., PDSCH), based on a currently configured RS. For example, the first apparatus 110 may report that the current tracking condition is sufficient to support MCS 20 or rank 3 on the PDSCH, without requiring additional reference signals.

In some example embodiments, the tracking performance requirement may be met if at least one of a MCS value or a rank value of the physical shared channel is equal to or above a threshold value. In some example embodiments, the physical shared channel may be configured with at least one codeword and the at least one codeword may be associated with same or different MCS values, and at least one of the first indication or the fifth indication may be determined based on a highest MCS associated with the at least one codeword. For example, if one codeword uses MCS 16 and another uses MCS 24, the tracking performance assessment may be based on MCS 24 to ensure the most demanding requirement is satisfied. In some example embodiments, the tracking time value may be per MCS per codeword associated with the physical shared channel. The different MCS levels across codewords may have different associated tracking time values, this may allow fine-grained control over reference signal usage and performance evaluation.

Examples of the content of the tracking related information have been described. It is to be understood that the tracking related information may include any suitable information related to the tracking time value and/or the tracking performance. Scope of the present disclosure is not limited in this regard.

In some example embodiments of the present disclosure, an apparatus such as UE may determine whether the apparatus is capable of performing a frequency and time tracking of a channel within a tracking time using a first TRS and a DMRS from a further apparatus. If the apparatus is capable of performing tracking, the apparatus transmits to the further apparatus, information associated with the determination, such as an indication of an extension of the tracking time, or information indicating that the tracking performance is valid. If the apparatus is not capable of performing tracking, the apparatus transmits a request for a second TRS to the further apparatus. In this manner, the apparatus may request a further TRS when the tracking performance is invalid or insufficient. The transmission of the TRS can be reduced, which may improve energy efficiency.

FIG. 4 illustrates an example signaling flow 400 for frequency and time tracking performance indication in accordance with some example embodiments of the present disclosure. The signaling flow 400 involves the first apparatus 110 and the second apparatus 120 in FIG. 1.

In operation, the second apparatus 120 transmits (4010), to the first apparatus 110, at least one RS, such as a first TRS and a DMRS. Correspondingly, the first apparatus 110 receives (4015) the first TRS and the DMRS. The first apparatus 110 determines (4020) whether the first apparatus 110 is capable of performing a frequency and time tracking of a channel (referred to as a “channel tracking”) within a tracking time using the first TRS and DMRS from the second apparatus 120. In other words, the first apparatus 110 may determine whether the channel tracking within the tracking time using the first TRS and DMRS is sufficient or valid.

If the first apparatus 110 determines (4020) that the first apparatus 110 is capable of performing the channel tracking, the first apparatus 110 transmits (4030), to the second apparatus 120, information associated with the determination (also referred to as information associated with tracking performance). Correspondingly, the second apparatus 120 receives (4035) the information.

In an example, the information associated with the determination may explicitly indicate an extension of the tracking time. That is, the first apparatus 110 may indicate the second apparatus 120 that the current tracking time of the first TRS may be extended. That is, the time duration during which the first apparatus 110 is able to perform tracking (and maintain certain requirement) may be extended. The time value of the tracking time may increase or be extended, which means that the current TRS configuration and the additional DMRS is good enough so the first apparatus 110 may perform the tracking longer than reported earlier. In other words, the second apparatus 120 may not need to transmit a further TRS. In this manner, the transmissions of the TRS may be reduced. In some examples, the indication of the extension may include a time extension value (referred to as a first time extension value) for extending the tracking time. The second apparatus 120 may determine when to transmit a subsequent TRS to the first apparatus 110 based on the extended tracking time. Alternatively, the time extension value may be predefined or pre-specified. The tracking time may be extended by a certain amount as specified. Alternatively, the time extension value may be configured by the second apparatus 120. For example, the second apparatus 120 may transmit a configuration of a second time extension value to the first apparatus 110.

Alternatively, or in addition, the information associated with the determination may include information indicating that tracking performance with the first TRS and DMRS is sufficient or valid. Such information may be regarded as or interpreted by the second apparatus 120 as an implicit indication for extending the tracking time or extending the usage of the first TRS. In response to receiving such implicit indication, the second apparatus 120 may be informed that no additional TRS is needed currently. The second apparatus 120 may thus refrain from transmitting further TRS(s). In this manner, the transmission of the TRS may be reduced.

With these embodiments, the first apparatus 110 such as UE may be capable of performing additional tracking (in addition to the TRS) based on the DMRS of PDCCH and/or PDSCH. In one example, the first apparatus 110 may indicate that current tracking performance is still sufficient based on the DMRS. The first apparatus 110 may be configured to indicate sufficient tracking performance.

In some example embodiments, if the first apparatus 110 determines (4020) that the first apparatus 110 is not capable of performing the channel tracking, the first apparatus 110 transmits (4040), to the second apparatus 120, a request for at least one further TRS such as a second TRS. Correspondingly, the second apparatus 120 receives (4045) the request for TRS. In some example embodiments, in response to receiving (4045) the request, the second apparatus 120 may transmit, to the first apparatus 110, the second TRS. In this manner, the second apparatus 120 may transmit additional TRS(s) to the first apparatus 110 when needed.

In some example embodiments, the first apparatus 110 may determine (4020) whether the first apparatus 110 is capable of performing the channel tracking using the first TRS and DMRS within the tracking time for supporting communication on the channel based on an MCS. For example, the first apparatus 110 may determine whether the tracking performance is adequate for supporting the communication on at least one DL channel based on the currently used MCS with additional DMRS.

It is to be understood that some conditions, features or options described with respect to FIG. 3 are also applicable to the signaling flow 400. For example, the first apparatus 110 may transmit, to the second apparatus 120, a value of the tracking time, and/or other information related to the channel tracking. The first apparatus 110 may transmit the value of the tracking time or an extension or reduction of the tracking time when updating the tracking time. The second apparatus 120 thus may be informed about the updating of the tracking time. Such updating may help the second apparatus 120 to schedule the subsequent TRS transmission. The details of the tracking time and the conditions for transmitting the tracking time may be similar to those described with respect to FIG. 3. For the purpose of simplification, the details thereof will not be repeated.

With these embodiments described with respect to FIG. 4, the first apparatus 110 such as UE may request for TRS when needed, and the network may provide TRS(s) when being requested. In this manner, non-periodic transmission for RSs according to the need may be achieved. Energy efficiency can thus be improved. In addition, it provides more scheduling flexibility for network.

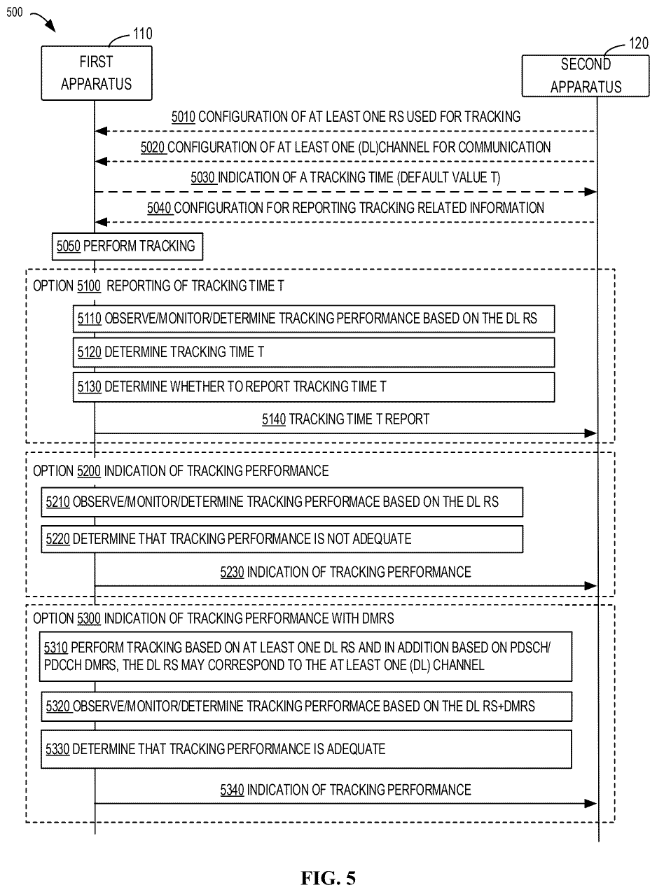

Further example embodiments regarding frequency and time tracking related information transmission will be described with respect to FIG. 5, which illustrates an example signaling flow 500 for frequency and time tracking of a channel in accordance with some example embodiments of the present disclosure. The signaling flow 500 involves the first apparatus 110 and the second apparatus 120 in FIG. 1.

In operation, the second apparatus 120 may transmit (5010) to the first apparatus 110, a configuration of at least one RS to be used for tracking by the first apparatus 110. The second apparatus 120 may further transmit (5020) to the first apparatus 110, configuration for configuring at least one DL channel for the subsequent communication. The second apparatus 120 may provide (5030) an indication of a tracking time, such as a default value T. The second apparatus 120 may transmit (5040) to the first apparatus 110, a configuration for tracking related information reporting. The configuration for tracking related information reporting may include at least one condition for the reporting, or other related parameter(s) or value(s). Details of the configured condition, parameter, or value have been described with respect to FIG. 3, and will not be repeated here.

The first apparatus 110 may perform (5050) tracking based on the at least one configured downlink RS (e.g., TRS, SSB, CSI-RS). These RSs may correspond to the DL channel configured for use in the communication.

In an option 5100, the first apparatus 110 may report the tracking time value (referred to as tracking time T). The first apparatus 110 may observe, monitor, or determine (5110) tracking performance based on the configured DL RS. The first apparatus 110 may determine (5120) a tracking time T. The first apparatus 110 may evaluate (5130) whether to report the determined tracking time T. Based on this evaluation, the first apparatus 110 may report the tracking time T to the second apparatus 120. For example, the first apparatus 110 may transmit (5140) to the second apparatus 120, a tracking time T report including the tracking time T.

In an option 5200, the first apparatus 110 may report or indicate the tracking performance. The first apparatus 110 may observe or determine (5210) that the tracking performance based on the DL RS is insufficient. The first apparatus 110 may determine (5220) that the tracking performance is not adequate for supporting the communication on at least one DL channel, for example, based on the current configured RS. Based on this determination, the first apparatus 110 may indicate that it is not able to meet the tracking performance. For example, the first apparatus 110 may transmit (5230) to the second apparatus 120, an indication of tracking performance.

In an option 5300, the first apparatus 110 may indicate to the second apparatus 120 of the tracking performance with DMRS. The first apparatus 110 may perform (5310) tracking based on the DL RS and further based on the DMRS associated with PDSCH or PDCCH. The first apparatus 110 may determine (5320) the tracking performance based on the combination of DL RS and DMRS. The first apparatus 110 may determine (5330) that the tracking performance is adequate for supporting communication on at least one DL channel, when enhanced by the additional tracking with DMRS. Based on this determination, the first apparatus 110 may indicate to the second apparatus 120 that the tracking performance is met. For example, the first apparatus 110 may transmit (5340) to the second apparatus 120, the indication of tracking performance.

With these embodiments, the first apparatus 110 such as UE may be configured with UE initiated tracking report event(s) or reporting part of the reported information. The tracking event or reporting may be associated with observed or estimated time or frequency tracking performance for reception of at least one channel. By reporting the tracking related information to the second apparatus 120 such as network, non-periodic transmission for RSs such as TRS may be supported. For example, the second apparatus 120 may transmit the RSS according to the need of the first apparatus 110. Energy efficiency can thus be improved. In addition, it provides more scheduling flexibility for network.

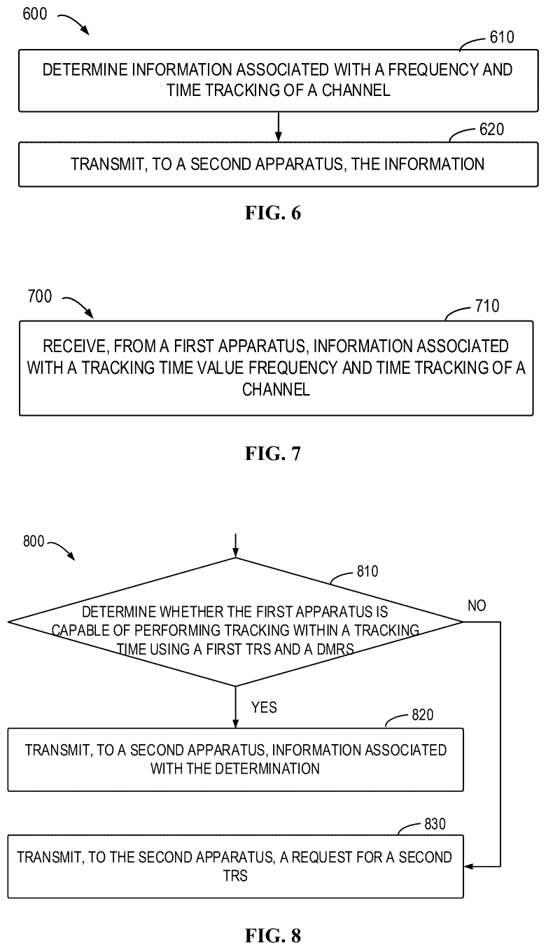

FIG. 6 shows a flowchart of an example method 600 implemented at a first apparatus in accordance with some example embodiments of the present disclosure. For the purpose of discussion, the method 600 will be described from the perspective of the first apparatus 110 in FIG. 1.

At block 610, the first apparatus 110 determines information associated with a frequency and time tracking of a channel.

At block 620, the first apparatus 110 transmits, to a second apparatus, the information. The information indicates at least one of: information of a tracking time value associated with a period of time for the frequency and time tracking, or tracking performance information for the frequency and time tracking.

In some example embodiments, the determining the information comprises determining the tracking time value based on at least one of: at least one parameter associated with at least one RS, a channel condition determined by the first apparatus, or a mobility status of the first apparatus.

In some example embodiments, the at least one RS comprises at least one of: a TRS, or a DMRS.

In some example embodiments, the type of the TRS comprises one of: a periodic TRS, an aperiodic TRS, or a semi persistent TRS.

In some example embodiments, the at least one parameter associated with the at least one RS comprises at least one of: a periodicity of the at least one RS, a number of more than one consecutive symbol of the at least one RS, a number of at least one symbol in a slot of the at least one RS, a bandwidth of the at least one RS, or a pre-configured value associated with the tracking time value.

In some example embodiments, the channel condition determined by the first apparatus is determined based on at least one of: an aperiodic TRS, or a QCL source RS of the aperiodic TRS.

In some example embodiments, the QCL source RS comprises one of the following: a channel state information reference signal, or a synchronization signal block.

In some example embodiments, the transmission of the information associated with the frequency and time tracking is caused by at least one of the following: a determination that the tracking time value is invalid, a change to the tracking time value, or a reception of an aperiodic TRS.

In some example embodiments, the information of the tracking time value comprises at least one of: a first indication indicating the tracking time value. The tracking time value indicates how long the first apparatus is able to perform tracking or meet a tracking performance requirement, based on a currently configured RS, a second indication indicating an extension of the tracking time value, a third indication indicating that the tracking time value is valid, or a fourth indication indicating that the tracking time value is invalid. The tracking performance information comprises a fifth indication that the first apparatus is able to meet the tracking performance requirement for at least one of: MCS or rank of a physical shared channel, based on a currently configured RS.

In some example embodiments, the tracking performance requirement is met when at least one of a MCS value or a rank value of the physical shared channel is equal to or above a threshold value.

In some example embodiments, the physical shared channel is configured with at least one codeword, the at least one codeword being associated with same or different MCS values, and at least one of the first indication or the fifth indication is determined based on a highest MCS associated with the at least one codeword.

In some example embodiments, the tracking time value is per MCS per codeword associated with the physical shared channel.

In some example embodiments, the first indication of the tracking time value is expressed in time, symbols, slots, or codepoints mapping to configured or predefined values.

In some example embodiments, the information associated with the frequency and time tracking is comprised in at least one of: a tracking report, a CSI report, UCI, a MAC CE, or a RRC message.

In some example embodiments, the method 600 further comprises: receiving a configuration for transmitting the information associated with the frequency and time tracking. The configuration comprises at least one of: at least one condition for transmitting the information associated with the frequency and time tracking, at least one configured tracking time value, or indication of content of the information associated with the frequency and time tracking.

In some example embodiments, the first apparatus is or is comprised in a terminal device, and the second apparatus is or is comprised in a network device.

In some example embodiments, a first apparatus capable of performing any of the method 600 (for example, the first apparatus 110 in FIG. 1) may comprise means for performing the respective operations of the method 600. The means may be implemented in any suitable form. For example, the means may be implemented in a circuitry or software module. The first apparatus may be implemented as or included in the first apparatus 110 in FIG. 1.

FIG. 7 shows a flowchart of an example method 700 implemented at a second apparatus in accordance with some example embodiments of the present disclosure. For the purpose of discussion, the method 700 will be described from the perspective of the second apparatus 120 in FIG. 1.

At block 710, the second apparatus 120 receives, from a first apparatus, information associated with frequency and time tracking of a channel. The information indicates at least one of: information of a tracking time value associated with a period of time for the frequency and time tracking, or tracking performance information for the frequency and time tracking.

In some example embodiments, the method 700 further comprises: transmitting, to the first apparatus, a configuration for transmitting the information associated with the frequency and time tracking. The configuration comprises at least one of: at least one condition for transmitting the information associated with the frequency and time tracking, at least one configured tracking time value, or indication of content of the information associated with the frequency and time tracking.

In some example embodiments, the information of the tracking time value comprises at least one of: a first indication indicating the tracking time value. The tracking time value indicates how long the first apparatus is able to perform tracking or meet a tracking performance requirement, based on a currently configured RS, a second indication indicating an extension of the tracking time value, a third indication indicating that the tracking time value is valid, or a fourth indication indicating that the tracking time value is invalid. The tracking performance information comprises a fifth indication that the first apparatus is able to meet the tracking performance requirement for at least one of: modulation coding scheme (MCS), or a rank of a physical shared channel, based on a currently configured RS.

In some example embodiments, the tracking performance requirement is met when at least one of a MCS value or a rank value of the physical shared channel is equal to or above a threshold value.

In some example embodiments, a second apparatus capable of performing any of the method 700 (for example, the second apparatus 120 in FIG. 1) may comprise means for performing the respective operations of the method 700. The means may be implemented in any suitable form. For example, the means may be implemented in a circuitry or software module. The second apparatus may be implemented as or included in the second apparatus 120 in FIG. 1.

FIG. 8 shows a flowchart of an example method 800 implemented at an apparatus in accordance with some example embodiments of the present disclosure. For the purpose of discussion, the method 800 will be described from the perspective of the first apparatus 110 in FIG. 1.

At block 810, the first apparatus 110 determines whether the first apparatus 110 is capable of performing a frequency and time tracking of a channel within a tracking time using a first TRS and a DMRS.

At block 820, in accordance with a determination that the first apparatus 110 is capable of performing the frequency and time tracking within the tracking time, the first apparatus 110 transmits to a further apparatus information associated with the determination.

At block 830, in accordance with a determination that the apparatus is not capable of performing the frequency and time tracking within the tracking time value, the first apparatus 110 transmits to the further apparatus a request for a second TRS.

In some example embodiments, the information associated with the determination comprises at least one of: an indication of an extension of the tracking time, or information indicating that tracking performance with the first TRS and the DMRS is valid.

In some example embodiments, the indication of the extension comprises a first time extension value for extending the tracking time.

In some example embodiments, the method 800 further comprises: receiving, from the further apparatus, a configuration of a second time extension value for extending the tracking time.

In some example embodiments, the method 800 further comprises: determining whether the first apparatus 110 is capable of performing the frequency and time tracking using the first TRS and the DMRS within the tracking time for supporting communication on the channel based on a MCS value.

In some example embodiments, the method 800 further comprises: transmitting, to the further apparatus, a value of the tracking time.

In some example embodiments, the first apparatus 110 is or is comprised in a terminal device, and the further apparatus is or is comprised in a network device.

In some example embodiments, an apparatus capable of performing any of the method 800 (for example, the first apparatus 110 in FIG. 1) may comprise means for performing the respective operations of the method 800. The means may be implemented in any suitable form. For example, the means may be implemented in a circuitry or software module. The apparatus may be implemented as or included in the first apparatus 110 in FIG. 1.

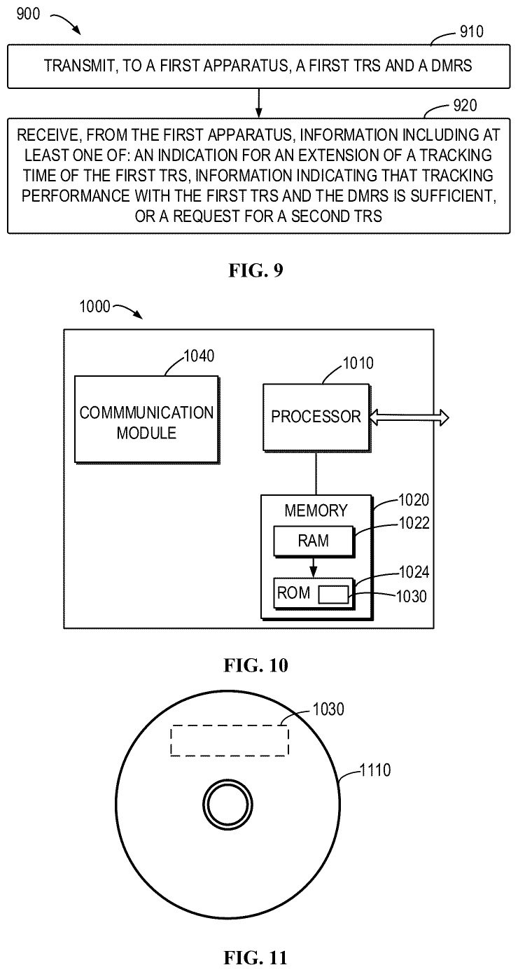

FIG. 9 shows a flowchart of an example method 900 implemented at an apparatus in accordance with some example embodiments of the present disclosure. For the purpose of discussion, the method 900 will be described from the perspective of the second apparatus 120 in FIG. 1.

At block 910, the second apparatus 120 transmits, to a further apparatus, a first TRS and a DMRS.

At block 920, the second apparatus 120 receives, from the further apparatus, information comprising at least one of: an indication for an extension of a tracking time of the first TRS for a frequency and time tracking of a channel, information indicating that tracking performance of the frequency and time tracking with the first TRS and the DMRS is valid, or a request for a second TRS.

In some example embodiments, the indication for the extension comprises a first time extension value for extending the tracking time.

In some example embodiments, the method 900 further comprises: transmitting, to the further apparatus, a configuration of a second time extension value for extending the tracking time.

In some example embodiments, the method 900 further comprises: receiving, from the further apparatus, a value of the tracking time.

In some example embodiments, the second apparatus 120 is or is comprised in a network device, and the further apparatus is or is comprised in a terminal device.

In some example embodiments, an apparatus capable of performing any of the method 900 (for example, the second apparatus 120 in FIG. 1) may comprise means for performing the respective operations of the method 900. The means may be implemented in any suitable form. For example, the means may be implemented in a circuitry or software module. The apparatus may be implemented as or included in the second apparatus 120 in FIG. 1.

FIG. 10 is a simplified block diagram of a device 1000 that is suitable for implementing example embodiments of the present disclosure. The device 1000 may be provided to implement a communication device, for example, the first apparatus 110 or the second apparatus 120 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 1022 and other volatile memories that will not last in the power-down duration. The memory 1020 may have instructions stored thereon.

The instructions may comprise a computer program 1030 which includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 3 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk or in the form of other data storage devices. The computer readable medium 1100 has the program 1030 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. An apparatus comprising:
at least one processor; and
at least one memory storing instructions that, when executed by the at least one processor, cause the apparatus to:
determine whether the apparatus is capable of performing a frequency and time tracking of a channel within a tracking time using a first tracking reference signal, TRS, and a demodulation reference signal, DMRS;
in accordance with a determination that the apparatus is capable of performing the frequency and time tracking within the tracking time, transmit to a further apparatus information associated with the determination; and
in accordance with a determination that the apparatus is not capable of performing the frequency and time tracking within the tracking time value, transmit to the further apparatus a request for a second TRS.

22. The apparatus of claim 21, wherein the information associated with the determination comprises at least one of:
an indication of an extension of the tracking time, or
information indicating that tracking performance with the first TRS and the DMRS is valid.

23. The apparatus of claim 22, wherein the indication of the extension comprises a first time extension value for extending the tracking time.

24. The apparatus of claim 21, wherein the apparatus is further caused to:
receive, from the further apparatus, a configuration of a second time extension value for extending the tracking time.

25. The apparatus of claim 21, wherein the apparatus is further caused to:
determine whether the apparatus is capable of performing the frequency and time tracking using the first TRS and the DMRS within the tracking time for supporting communication on the channel based on a modulation and coding scheme, MCS, value.

26. The apparatus of claim 21, wherein the apparatus is further caused to:
transmit, to the further apparatus, a value of the tracking time.

27. The apparatus of claim 21, wherein the apparatus is or is comprised in a terminal device, and the further apparatus is or is comprised in a network device.

28. An apparatus comprising:
at least one processor; and
at least one memory storing instructions that, when executed by the at least one processor, cause the apparatus to:
transmit, to a further apparatus, a first tracking reference signal, TRS, and a demodulation reference signal, DMRS; and
receive, from the further apparatus, information comprising at least one of:
an indication for an extension of a tracking time of the first TRS for a frequency and time tracking of a channel,
information indicating that tracking performance of the frequency and time tracking with the first TRS and the DMRS is valid, or
a request for a second TRS.

29. The apparatus of claim 28, wherein the indication for the extension comprises a first time extension value for extending the tracking time.

30. The apparatus of claim 28, wherein the apparatus is further caused to:
transmit, to the further apparatus, a configuration of a second time extension value for extending the tracking time.

31. The apparatus of claim 28, wherein the apparatus is further caused to:
receive, from the further apparatus, a value of the tracking time.

32. The apparatus of claim 28, wherein the apparatus is or is comprised in a network device, and the further apparatus is or is comprised in a terminal device.

33. A non-transitory computer readable medium comprising instructions stored thereon for causing an apparatus at least to perform:
determining, at an apparatus, whether the apparatus is capable of performing a frequency and time tracking of a channel within a tracking time using a first tracking reference signal, TRS, and a demodulation reference signal, DMRS;
in accordance with a determination that the apparatus is capable of performing the frequency and time tracking within the tracking time, transmitting to a further apparatus information associated with the determination; and
in accordance with a determination that the apparatus is not capable of performing the frequency and time tracking within the tracking time value, transmitting to the further apparatus a request for a second TRS.

34. The non-transitory computer readable medium of claim 33, wherein the information associated with the determination comprises at least one of:
an indication of an extension of the tracking time, or
information indicating that tracking performance with the first TRS and the DMRS is valid.

35. The non-transitory computer readable medium of claim 34, wherein the indication of the extension comprises a first time extension value for extending the tracking time.

36. The non-transitory computer readable medium of claim 33, further comprising:
receiving, from the further apparatus, a configuration of a second time extension value for extending the tracking time.

37. The non-transitory computer readable medium of claim 33, wherein determining whether the apparatus is capable of performing the frequency and time tracking comprises:
determining whether the apparatus is capable of performing the frequency and time tracking using the first TRS and the DMRS within the tracking time for supporting communication on the channel based on a modulation and coding scheme, MCS, value.

38. The non-transitory computer readable medium of claim 33, further comprising:
transmitting, to the further apparatus, a value of the tracking time.
